(19) United States
(12) Patent Application Publication
(10) Pub. No.: US 2002/0001287 A1
(43) Pub. Date: Jan. 3, 2002

(54) Data transmission in a telecommunications system

(76) Inventors: Martin Bergenwall, Espoo (FI); Juha Rasanen, Espoo (FI); Mikko Ohvo, Numminen (FI)

Correspondence Address: PILLSBURY WINTHROP LLP, 1600 TYSONS BOULEVARD, MCLEAN, VA, 22102, US

(21) Appl. No.: 09/891,607

(22) Filed: Jun. 27, 2001

Related U.S. Application Data
(63) Continuation of application No. PCT/FI99/01092, filed on Dec. 29, 1999.

(30) Foreign Application Priority Data
Dec. 31, 1998 (FI) 982854

(51) Int. Cl. H04L 12/26

(52) U.S. Cl. 370/230; 370/468

(57) ABSTRACT

The invention relates to a communications system comprising a transmitter (30) and a receiver (30) for transmitting transparent data over a connection (32) therebetween. The bandwidth (b₂) assigned to the connection (32) is wider than the bandwidth (b₁) actually required by a nominal bit rate of the transparent data so as allow the use of a retransmitting protocol over the connection by enabling data transmission to stop and wait for retransmission of the incorrectly received frames while a transparent connection with a constant delay and a constant bit rate and a low BER is provided to the user. The incoming transparent data stream with a constant bit rate is buffered into a transmission buffer (300) and the frames received over the retransmitting connection (32) are buffered into a receiving buffer (310) which outputs the transparent data at the constant nominal bit rate.

### RELATED APPLICATIONS

This a continuation of International Application PCT/FI99/01092 filed Dec. 29, 1999 which designated the U.S. and that International Application was filed in English.

### FIELD OF THE INVENTION

The invention relates to data transmission in a telecommunications system, and particularly in wireless telecommunications systems.

### BACKGROUND OF THE INVENTION

A wireless communications system refers generally to a telecommunications system which enables wireless communication between its users and a network. In a mobile communications system, users can move within the service area of the system. A typical mobile communications system is a public land mobile network (PLMN).

In a second-generation (2G) mobile communications system, such as GSM (Global System for Mobile Communication), speech and data is transferred in a digital format. In digital mobile communications systems, there are several other services available in addition to the conventional speech transmission: short messages, facsimile service, data transmission, etc. The services of a mobile communications system can be generally categorized into teleservices and bearer services. Bearer service is a telecommunications service which establishes the transfer of signals between user-network interfaces. The bearer services include the modem service, for example. In a teleservice, terminal equipment services are also offered by the network. Speech, facsimile and video text services are important teleservices. The bearer services are usually sub-grouped according to a specific feature into asynchronous bearer services and synchronous bearer services, for instance. Within each of these sub-groups, there is a set of bearer services, such as a transparent service (T) and a non-transparent service (NT). In the transparent service, the transferred data is unstructured and the transmission errors are corrected by channel coding only. In the non-transparent service, the transferred data is structured into protocol data units (PDU) and the transmission errors are corrected using (in addition to channel coding) automatic retransmission protocols. In the GSM systems, for example, such a retransmitting link protocol is called a radio link protocol (RLP). Such a link protocol is also generally referred to as link access control (LAC).

Transparent connections are by definition connections with a constant delay but typically with a relatively high bit error rate (BER). The bit rate of the transparent connection is constant. The BER can be decreased by adding more forward error connection (FEC) bits (such as convolutional coding) to the data, i.e., by increasing the QoS (quality of service) of the transmission. Unfortunately, a good FEC increases the bandwidth requirements considerably. Further, it is a specific feature in the wireless communications systems that the transmission errors often appear in short bursts during transmission over an air interface, and thereby the use of a good FEC all the time during the transmission (i.e., also during the periods with low error rate) is quite inefficient, especially if a good BER is desired. Similar problems may also be encountered in other telecommunications systems and in any data transmission requiring a substantially constant bit rate and transmission delay.

### DISCLOSURE OF THE INVENTION

The idea of the present invention is to decrease the BER of data transmission in a data bearer service without loosing the transparent nature of the transmission, i.e., the constant delay and the constant bit rate.

An object of the present invention is a method of transmitting data requiring a substantially constant transmission delay and a substantially constant bit rate, such as transparent data, over a connection between a transmitting end and a receiving end, characterized by steps of

assigning to said connection a bandwidth wider than a bandwidth required by a nominal bit rate of said data, and

utilizing a retransmitting transmission protocol over said connection.

Another object of the invention is a communications system comprising a transmitter and a receiver for transmitting data requiring a substantially constant transmission delay and a substantially constant bit rate, such as transparent data, over a connection therebetween, characterized by said connection having a retransmitting transmission protocol and a bandwidth wider than a bandwidth required by a nominal bit rate of said data.

A still further object of the invention is a subscriber terminal in a communications system, said subscriber terminal comprising a transceiver for transmitting and receiving data requiring a substantially constant transmission delay and a substantially constant bit rate, such as transparent data, over a connection to and from another party, characterized by said connection having a retransmitting transmission protocol and a bandwidth wider than a bandwidth required by a nominal bit rate of said data.

In the present invention, the bandwidth assigned to a connection is wider than a bandwidth actually required by a nominal bit rate of the transparent data. This allows the use of a retransmitting protocol over the connection. The retransmission of incorrectly received frames is a more efficient way to provide a good BER than a good FEC. The bandwidth of the connection being wider than that required by the nominal bit rate of the transparent data enables the transmission to stop and wait for retransmission of the incorrectly received frames while a transparent connection with a constant delay and a constant bit rate and a low BER is provided to the user. The incoming transparent data stream with a constant bit rate is buffered into a transmission buffer in the transmitter, and the frames received over the retransmitting connection are buffered into a receiving buffer in a receiver which forwards (outputs) the transparent data at the constant nominal bit rate. Thus, due to the wider bandwidth of the retransmitting connection, a predetermined number of retransmissions of corrupted data frames is allowed while maintaining a ‘virtual’ transparent data transmission at a constant bit rate through the connection. For the end-user, the connection provides a normal transparent bearer service with better BER. If the bandwidth of the connection were equal to a nominal bandwidth required by the transparent data transmission, the transmission could not stop and wait for retransmission without violating the constant delay and bit rate requirements of the transparent connection.

The bandwidth of the retransmitting connection may be selected to be high enough for enabling the retransmission of the corrupted frames in any situation. However, this may be inefficient with regard to using the channel capacity of the communications system, since extra bandwidth is reserved for very difficult interference situations which occur very seldom. Further, especially in wireless communication, there may be interference peaks which may result in that the retransmitting connection is not able to fill the receiving buffer with uncorrupted data at the required constant rate. According to an embodiment of the invention, if there are too many frames to be transmitted so that the receiving buffer at the receiver is running out of uncorrupted data, the receiver is arranged to accept and forward the incorrectly received data, so that the constant bit rate and the constant delay is maintained. This is acceptable since the transparent transmission does not guarantee error-free transmission.

In a further embodiment of the invention, the efficiency of the use of channel capacity is improved, for example in a multiplexed environment, by dynamically requesting extra bandwidth for the connection when needed. As a consequence, more channel capacity can be requested and allocated to the connection at the setup phase or during the call in order to improve or maintain the BER. The communications system may, for example, set the bandwidth of the connection according to the QoS (e.g. BER) required by the end- users. During the connection, the bandwidth may be dynamically adjusted when changes (reduction or improvement) in the quality of the connection are detected. Under good transmission conditions without any errors, no retransmissions are needed and the extra bandwidth is not required and may be released. When the extra bandwidth is not fully used but not released either, some fill data may be inserted on a regular basis into the data transmitted over the connection in order to fill up the received bandwidth. The fill is removed from the data at the receiver.

In a preferred embodiment of the invention, the retransmitting connection is provided by implementing the transparent connection over a retransmitting lower layer. In third-generation networks, the user may be provided with a circuit-switched transparent connection over a retransmitting medium access control (MAC) layer. The present invention improves the quality of real-time video and multimedia calls, for example, particularly in third-generation mobile communications systems. For example, as the power control (PC) algorithm defined for the WCDMA is able to provide a FER (Frame Error Rate) value of 0.01, the present invention can provide almost error-free transmission for speech. A typical extra bandwidth required would be only approximately one percent over the bandwidth required by transparent data transmission.

### BRIEF DESCRIPTION OF THE DRAWINGS

In the following, the invention will be described in greater detail by means of the preferred embodiments with reference to the accompanying drawings in which

FIG. 1 shows a simplified UMTS architecture,

FIG. 2 illustrates an example of the protocol structure which may be used in the UMTS system,

FIG. 3 illustrates a transparent transmission setup according to the present invention,

FIG. 4 illustrates normal data transmission without errors over the connection according to the invention,

FIG. 5 illustrates retransmission of one data frame incorrectly received over the connection according to the invention, and

FIG. 6 illustrates retransmission of several incorrectly received frames over the connection according to the invention.

### THE PREFERRED EMBODIMENTS OF THE INVENTION

In the following, the preferred embodiments of the invention are in the following described as implemented in the UMTS system. The invention can be used in any telecommunications system requiring transparent data transmission with a low BER. As used herein, the term ‘transparent data’ is intended to refer to any data, normally real-time data or information, which requires a substantially constant transmission delay and bit rate.

At present, third-generation mobile systems, such as the universal mobile telecommunications system (UMTS) and the future public land mobile telecommunications system (FPLMTS), later renamed IMT-2000 (International Mobile Telecommunication 2000), are being developed. The UMTS is being standardized in ETSI (European Telecommunication Standard Institute) whereas ITU (International Telecommunication Union) is defining the IMT-2000 system. The radio interface is likely to be based on a wide band CDMA (Code Division Multiple Access), and, therefore, third generation systems are often referred to as wide band CDMA systems (WCDMA). These future systems are basically very alike.

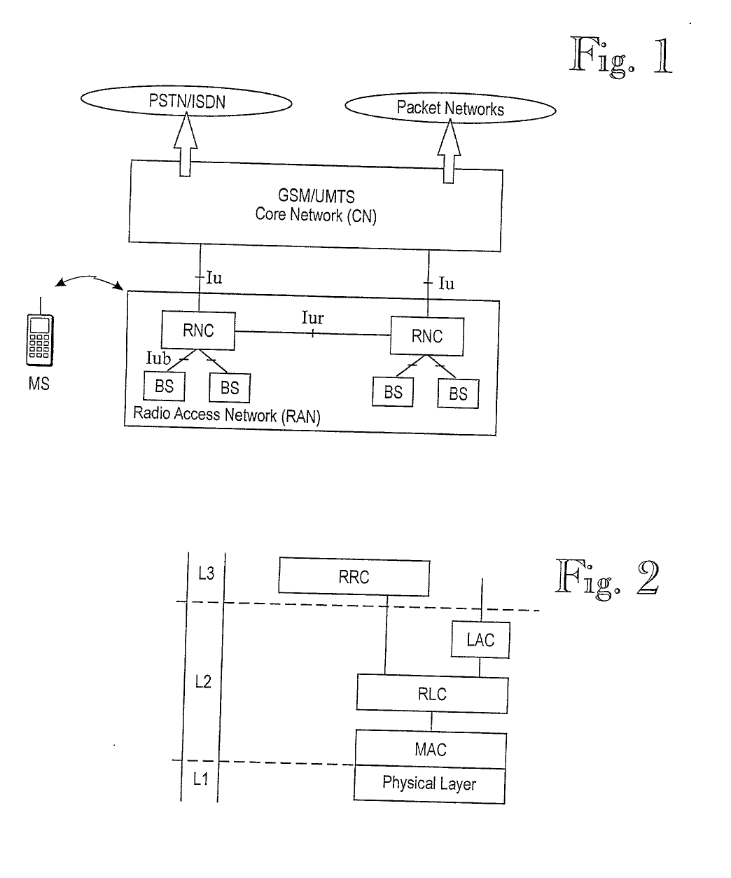

FIG. 1 shows a simplified UMTS architecture with the external reference points and interfaces to the UMTS terrestrial radio access network, UTRAN. The UTRAN consists of a set of radio access networks (RAN), also called radio network sub-systems (RNS), connected to the core network CN through an interface Iu. These radio network sub-systems can be interconnected through an interconnection point (reference point) Iur. The interfaces Iu(s) and Iur are logical interfaces. Iur can be conveyed over a direct physical connection between RANs or via any suitable transport network. Each RAN is responsible for the resources of its set of cells. For each connection between a mobile station MS and the UTRAN, one RAN is the serving RAN. The RAN consists of a radio network controller RNC and a multiplicity of base stations BS. The RNC is responsible for the handover decisions that require signalling to the MS. The base stations are connected to the RNC through the Iub interface. The core network CN is a conventional or future telecommunications network modified to efficiently utilize the UTRAN in wireless communication. Second-generation mobile communications systems, such as GSM, ISDN (Integrated Services Digital Network), B-ISDN (Broadband ISDN), PDN (Packet Data Network), ATM (Asynchronous Transfer Mode), etc. are considered suitable core networks.

FIG. 2 gives an overview of the assumed protocol environment in third-generation systems. Categorically, we can find three layers of the ISO/OSI layer model (International Standards Organization/Open System Interconnection): physical layers (Layer 1, L1), data link layer (Layer 2, L2), and network layer (Layer 3, L3). In FIG. 2, the layer L3 includes a radio resources control (RRC) protocol and upper user-plane protocols. RRC takes care of radio resources management. It negotiates the quality of service (QoS) for a bearer service and, based on that, chooses the needed transport format(s), bit rates, type of coding, physical layer multiplexing, performs allocation (codes, etc.), allocates identifiers for MSs and bearer services, signals these parameters to MS, and supervises all handovers. User-plane protocols relate to any upper layer transmission or signaling protocols. As used herein, the term ‘L3 protocols’ may also include the link access protocol LAC setup between the MS and the core network CN, although the LAC may also be said to be an L2 protocol. The LAC provides a low BER transmission of user data. As regards the present invention, the transparent data transmission layer (connection) may be established in the LAC layer.

The layer L2 functions include the radio link control (RLC) protocol and the medium access control (MAC). The RLC provides a reliable radio-solution-dependent link over the radio path. Under the RLC, the MAC function controls the mapping of the RLC protocol data units (RLC PDUs) into a physical channel in the physical layer. The MAC also includes a retransmission capability. The physical layer includes all the schemes and mechanisms used to make communication possible on the radio channel. These mechanisms include, for example, modulation, power control, coding and timing. The maximum data rate in the radio interface will be 2 Mbit/s.

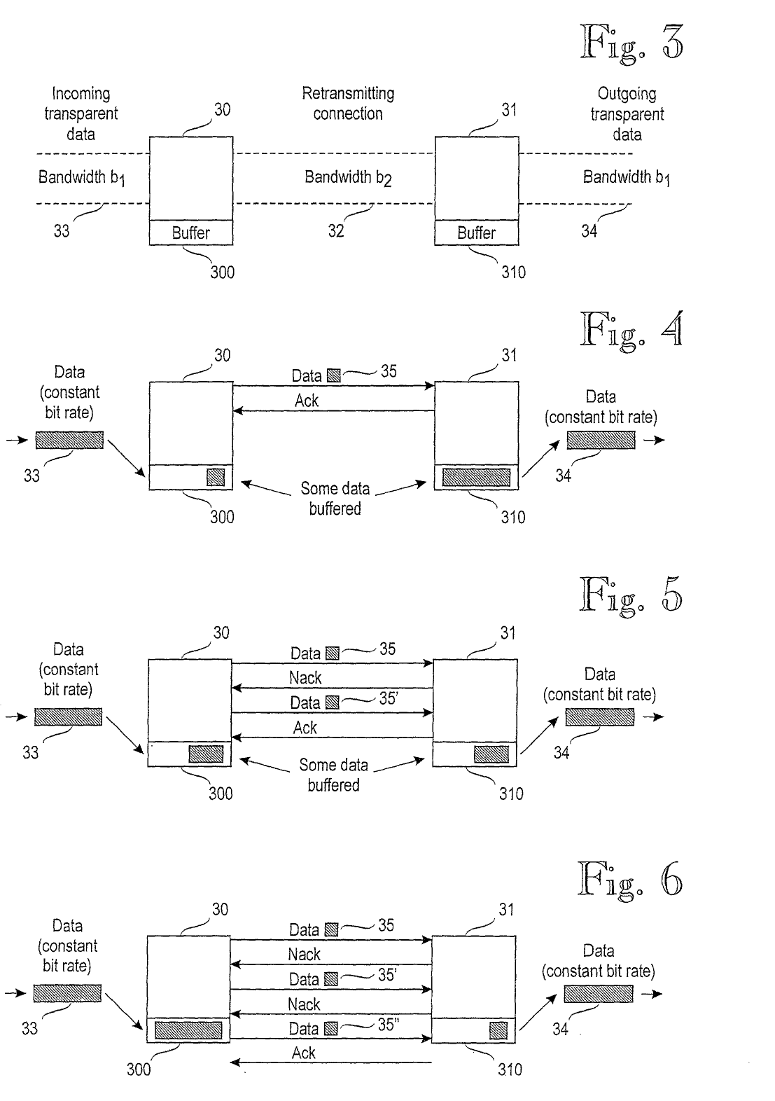

FIG. 3 illustrates a connection setup of a transparent data transmission according to the present invention. A connection 32 is set up between a transmitter 30 and a receiver 31. The connection may be a circuit-switched connection, a virtual connection (such as ATM), a packet-switched connection, etc. There is also a channel for signaling the acknowledgement messages (Ack) and/or the negative acknowledgement messages (Nack) from the receiver to the transmitter. Very often the data transmission is bidirectional so that the configuration as shown in FIG. 3 is set up in both directions. The transmitter 30 comprises a transmitting buffer 300 and the receiver 31 comprises a receiving buffer 310. The end-to-end transparent data connection has a constant bit rate R1 which requires a bandwidth b₁. As a consequence, the transparent data coming into the transmitter 30 and going out from the receiver 31 has a constant bit rate R1 and a bandwidth b₁.

In accordance with the present invention, a circuit-switched transparent connection 32 having a bandwidth b₂, which is wider than the bandwidth b₁ of the incoming and outgoing transparent data, is set up between the transmitter 30 and the receiver 31. Further, the lower layer, such as the MAC layer, under the transparent connection 32 is configured to be a retransmitting layer in order to improve the error correction and to decrease the BER of the transparent connection 32. The incoming transparent data is buffered into the transmitting buffer 300 prior to transmission over the connection 32 to the receiver 31 in which the received data is buffered into the receiving buffer 310. The retransmitting protocol will control the retransmission of incorrectly received data as will be described in more detail below. In addition to allowing the use of the retransmitting protocol, the buffers 300 and 310 ensure that the transparent data is input to the transmitter 30 and output from the receiver 31 at the constant bit rate R1 although the instantaneous bit rate may vary on the connection 32 due to the varying number of retransmissions.

It should be appreciated that the generic configuration shown in FIG. 3 and the operation described in FIGS. 4, 5 and 6 is applicable to any connection between any transmitter and receiver in any communications system. In a mobile communications system, one transmitter/receiver is typically the mobile station and the other transmitter/receiver is located in a network element on the network side. In FIG. 1, for example, the receiver or transmitter of the network side may be located in the base station BS, in the radio network controller RNC or the core network CN. There may also be several legs independently employing the principle of the present invention. For example, there may be one retransmitting connection according to the present invention between the MS and the BS, and another retransmitting connection between the BS and the RNC.

Let us assume that the retransmitting connection 32 is set up between the RNC and the MS over the interface Iub and the radio interface. The RNC allocates the required transmission capacity and radio capacity with the bandwidth b₂ to the connection 32. The RNC may determine the bandwidth b₂ according to the bearer service or the Qos (such as the required BER) requested for the connection by the MS or the other party. The extra capacity may be approximately 1 percent of the bandwidth b₁ for speech transmission, for example. The bandwidth b₂ may be assigned at the setup phase of the connection and maintained unchanged throughout the connection. The assigned bandwidth may, however, not be used by the connection all the time, but on demand. For example, the bandwidth b₂ may be dynamically requested and changed during the connection when needed. The need for decreasing or increasing the bandwidth b₂ may be determined on the basis of the quality of the connection, for example. The speed at which the value of the bandwidth b₂ can follow the actual need of the extra capacity depends primarily on how fast the network is able to reallocate capacity to and from the connection.

The data transmission over the connection 32 in FIG. 3 will be now described with reference to FIGS. 4, 5 and 6.

FIG. 4 illustrates normal data transmission without errors occurring on the connection 32. The transmitter 30 receives the transparent data with a constant bit rate to the transmitting buffer 300 and transmits the data in MAC frames 35 to the receiver 31. Due to the extra capacity of the connection 32, the transmitter 30 also sends fill data to the receiver 31. When the MAC frame 35 is received correctly, the receiver 31 acknowledges the frame and no retransmission is needed. The receiver 31 fills the receive buffer to an appropriate level in the beginning of the data transmission in order to prepare for possible retransmission situations. After the adjustment of the receive buffer level, the receiving buffer 310 outputs the transparent data 34 at the constant bit rate. The receiver 31 discards the fill data sent by the transmitter 30. When there are no errors, the only delay is caused by a full receiving buffer 310. However, the buffers in the transmitter and in the receiver are selected to be small enough to meet the delay requirement of transparent transmission. The delay is always constant during the call.

FIG. 5 illustrates the transmission and retransmission of an incorrectly received MAC frame. The transmitter 30 transmits a MAC frame 35 from the transmitting buffer 300 as described above in FIG. 4. The frame 35 is corrupted during transmission over the connection 32 and is incorrectly received at the receiver. The receiver 31 requests for retransmission of the corrupted frame 35 by sending the negative acknowledgement Nack to the transmitter 30. In a dynamic environment, extra channel capacity is requested at the cost of other (non-real-time) connections using the same underlying channel. The receiving buffer 310 which is not empty allows the receiver to wait for the retransmission for a short while. The transmitter 30 retransmits the MAC frame 35′, as fast as possible. Upon correctly receiving the retransmitted frame 35′, the receiver 31 transmits the acknowledgement Ack to the transmitter 30. As a consequence to the transmission errors and the resulting retransmissions, the receiving buffer 310 starts to empty and the transmitting buffer 300 starts to fill.

FIG. 6 illustrates a case where the receiving buffer 10 is becoming empty due to several incorrectly received MAC frames. The transmitter 30 transmits a MAC frame 35 to the receiver 31. The frame 35 is corrupted during the transmission through the connection 32 and incorrectly received by the receiver 31. The receiver 31 transmits the Nack message to the transmitter 30 which retransmits the frame 35′. The frame 35′ is again corrupted, and, therefore, the negative acknowledgement Nack is transmitted by the receiver 31 to the transmitter 30. The transmitter 30 retransmits the MAC frame 35″ a second time, but the frame is again corrupted during the transmission. Meanwhile, the receiver 31 outputs data from the receiving buffer 310 at the constant bit rate, and the uncorrupted data in the receiving buffer 310 is running out due to the several incorrectly received frames. If the receiving buffer 310 were allowed to become totally empty, the receiving buffer 310 would fail to output data 34 at the constant bit rate required by transparent transmission. Therefore, the receiver 31 will decide to accept and output the corrupted frame 35″ in order to avoid an empty receiving buffer, and transmits the acknowledgement message ACK to the transmitter 30 for this frame. As a consequence, the transmitter 30 assumes that the frame 35″ was correctly received and starts to transmit a new MAC frame with new data. Forwarding of the corrupted data from the receiver 31 is acceptable since transparent transmission does not guarantee error-free transmission in the first place. A more important requirement is that the constant bit rate and the constant delay are maintained. When the number of the errors and the resulting retransmissions decreases, the receiving buffer 310 will gradually fill up while the transmitting buffer becomes emptier because of the slightly wider bandwidth and the slightly higher bit rate of the connection 32 as compared with the constant bit rate of data streams 33 and 34. Some time after the error peak, the situation will be like shown in FIG. 4. In wireless communications, the burst of errors may be due to a multipath fading or an interfering co-channel signal, for example.

In the case illustrated in FIG. 6, there is a risk that the transmitter fails to receive the acknowledgement message ACK for the corrupted frame 35″ which was accepted in order to avoid an empty receiving buffer 310. In that case, the transmitter 30 may retransmit the same frame, which may result in an empty receiving buffer 310 due to the lack of new frames. To avoid this problem, the transmitting buffer 300 and the receiving buffer 310 are of equal size in a further embodiment of the invention. As a consequence, the transmitting buffer will become full as the receiving buffer becomes empty, and the transmitter will transmit new frames to the receiver when the fill level of the transmitting buffer exceeds a predetermined threshold although the receiver has not acknowledged all the previous frames. As a result the receiving buffer can never become empty.

The present invention is well suited for a MAC-based retransmitting protocol where the length of the transmitted frames is short, the transmission delays are short and, consequently, the retransmissions can be carried out fast.

The invention has been described above by means of preferred embodiments to illustrate the principles of the invention. Changes and modifications of the invention will be apparent to a person skilled in the art without departing from the scope and spirit of the accompanying claims.

1. A method of transmitting transparent data requiring a substantially constant transmission delay and a substantially constant bit rate over a connection between a transmitting end and a receiving end, comprising steps of assigning to said connection a bandwidth wider than a bandwidth required by a nominal bit rate of said data,
utilizing a retransmitting transmission protocol over said connection, employing said retransmitting protocol in a protocol layer underlying a transparent layer.

2. A method according to claim 1, wherein said utilization of the retransmitting protocol comprises steps of
buffering the transmitted data at the transmitting end,
retransmitting the data corrupted during transmission over said connection and requested by the receiving end,
buffering the received data at the receiving end and forwarding the buffered data at a constant bit rate meeting the bit rate and delay requirements of the data,
forwarding from the receiving end the incorrectly received data when the bit rate and delay requirements of the data do not allow to wait for the retransmission of the data, and forwarding the uncorrupted data otherwise.

3. A method according to claim 1 or 2, comprising
buffering the data into a transmitting buffer and a receiving buffer of equal size,
transmitting new data without waiting for an acknowledgement for previous data if the transmitting buffer fills up to a predetermined level, in order to avoid the receiving buffer becoming empty.

4. A method according to claim 1 or 2, comprising transmitting fill data over the connection when the wider bandwidth is not used for transmission and retransmission of the data.

5. A method according to claim 1 or 2, comprising assigning said wider bandwidth to the connection or using the assigned bandwidth dynamically on demand.

6. A method according to any one of claims 1 or 2, wherein said connection is between a subscriber station and a network element over an air interface in a wireless communications system.

7. A method of transmitting transparent data requiring a substantially constant transmission delay and a substantially constant bit rate over a connection between a transmitting end and a receiving end, comprising
assigning to said connection a bandwidth wider than a bandwidth required by a nominal bit rate of said data,
utilizing a retransmitting transmission protocol over said connection, employing said retransmitting protocol in medium access control (MAC) layer underlying a transparent layer.

8. A communications system comprising
a transmitter and a receiver for transmitting data requiring a substantially constant delay and a substantially constant bit rate over a connection therebetween, said connection having a retransmitting transmission protocol and a bandwidth wider than a bandwidth required by a nominal bit rate of said data, said retransmitting protocol being a retransmitting protocol in a protocol layer underlying a transparent layer.

9. A system according to claim 8, wherein said retransmitting protocol is a medium access control (MAC) layer.

10. A system according to claim 8 or 9, comprising
a transmission buffer for the transmitted data in the transmitter (30),
the transmitter being arranged to retransmit the data corrupted during transmission over said connection and requested by the receiver,
a receiving buffer in the receiver for forwarding the buffered data at a constant bit rate meeting the bit rate and delay requirements of the data,
the receiver being arranged to forward the corrupted data when the bit rate and delay requirements of the data do not allow to wait for the retransmission of the data, and to forward the uncorrupted data otherwise.

11. A system according to claim 10, comprising
the transmitting buffer and the receiving buffer being of equal size,
the transmitter being arranged to transmit new data without waiting for an acknowledgement for previous data if the transmitting buffer fills up to a predetermined level, in order to avoid the receiving buffer becoming empty.

12. A system according to claim 8 or 9 , wherein the transmitter is arranged to transmit fill data over the connection when the wider bandwidth is not used for transmission and retransmission of the data.

13. A system according to claim 8 or 9 comprising a dynamic allocation of said wider bandwidth to the connection on demand.

14. A system according to claim 8 or 9, wherein said retransmitting protocol is employed in a protocol layer underlying the transparent layer.

15. A system according to claim 8 or 9, comprising a medium access control (MAC) layer underlying the transparent connection layer, said retransmitting protocol being employed in the MAC layer.

16. A system according to claim 8 or 9, wherein said connection is between a subscriber station and a network element over an air interface in a wireless communications system.

17. A subscriber terminal in a communications system, said subscriber terminal comprising a transceiver for transmitting and receiving transparent data requiring a substantially constant transmission delay and a substantially constant bit rate over a connection to and from another party, said connection (having a retransmitting transmission protocol and a bandwidth wider than a bandwidth required by a nominal bit rate of said data, said retransmitting protocol is a retransmitting protocol in a protocol layer underlying a transparent layer.

18. A subscriber terminal according to claim 17, wherein a protocol layer underlying a transparent layer, is a medium access control (MAC) layer.

19. A subscriber terminal according to claim 17 or 18, comprising
a transmission buffer for the transmitted data,
the transceiver being arranged to retransmit the data corrupted during transmission over said connection (and requested by the other party,
a receiving buffer,
the transceiver being arranged to forward the corrupted data when the bit rate and delay requirements of the data do not allow to wait for retransmission of the data, and to forward the uncorrupted data otherwise.
